(19) United States
(12) Patent Application Publication
(10) Pub. No.: US 2008/0231247 A1
(43) Pub. Date: Sep. 25, 2008

(54) Semiconductor device

(76) Inventor: Osamu Uehara, Chiba-shi (JP)

Correspondence Address: BRUCE L. ADAMS, ESQ;ADAMS & WILKS, SUITE 1231, 17 BATTERY PLACE, NEW YORK, NY, 10004, US

(21) Appl. No.: 12/070,299

(22) Filed: Feb. 15, 2008

(30) Foreign Application Priority Data
Feb. 17, 2007 (JP) 2007-037224

(51) Int. Cl. G05F 1/575

(52) U.S. Cl. 323/284

(57) ABSTRACT

To obtain a switching regulator which, when a load suddenly decreases, suppresses overshoot of output voltage without oscillating the output voltage is provided, even if being a current mode switching regulator, the present invention provides a semiconductor device for a switching regulator for converting input direct current voltage input from a direct current power supply to set direct current output voltage and outputting the output voltage from an output terminal, including: an overvoltage protection circuit for: comparing a target voltage with the output voltage at the output terminal; and making the output terminal in a discharge state when the output voltage exceeds the target voltage.

### BACKGROUND OF THE INVENTION

1. Field of the Invention

The present invention relates to a semiconductor device for a current mode switching regulator which controls output voltage using direct current input power supply based on detected values of output voltage and output current.

2. Description of the Related Art

As a current mode step-down switching regulator in which direct current voltage is input from a direct current power supply, and the output direct current voltage is supplied to a load, there is used a circuit as illustrated in FIG. 5 (see, for example, JP 2005-45942 A). The current mode step-down switching regulator illustrated in FIG. 5 has a switch 207, a pulse width control circuit 205, a diode 202, a capacitor 212, a coil 208, a current detection circuit 206, and a voltage detection circuit 204. A voltage Vin which is input from a direct current power supply 201 is stepped down, and the stepped-down output voltage is supplied to a load 209.

In this circuit, the pulse width control circuit 205 outputs to the switch 207 a drive pulse having a predetermined duty ratio (pulse width).

By virtue of this, for example, the switch 207 is on during a drive pulse being input, and current passes from the direct current power supply 201 to the coil 208. In this case, the input voltage Vin is built up in the coil 208 in the form of electric energy (i.e., charge).

The switch 207 is off during a drive pulse is not being input, and electric energy which has been built up in the coil 208 is transferred to the capacitor 212.

Therefore, in the current mode step-down switching regulator illustrated in FIG. 5, electric energy which has been built up in the coil 208 is equated (integrated) by the capacitor 212, and the equated (integrated) voltage is supplied to the load 209.

In the operation described above, when the load 209 suddenly decreases or increases, due to delay in response in, for example, phase compensation of the voltage detection circuit 204 for detecting output voltage, overshoot or undershoot of the output voltage is caused.

More specifically, because the voltage detection circuit 204 cannot respond to the sudden change in the load, voltage information for adjusting the pulse width to be sent to the pulse width control circuit 205 delays, and the duty ratio used in turning on/off the switch 207 delays from the time when the load decreases or increases. As a result, the overshoot or undershoot is caused.

The current detection circuit 206 is provided in order to control the duty ratio used in turning on/off the switch 207 so as not to be delayed from the timing at which the load 209 changes. The current detection circuit 206 detects the output current passing through the coil 208, that is, detects change in the current such as decrease or increase in the current, and outputs to the pulse width control circuit 205 current information with regard to increase or decrease in the current.

According to the current information which is input from the current detection circuit 206, the pulse width control circuit 205 changes the duty ratio of the pulse used in turning on/off the switch 207, and controls on/off of the switch 207 according to sudden increase or decrease in the load 209, thereby accommodating sudden increase or decrease in the load 209 to suppress the overshoot or undershoot.

As described above, in the current mode step-down switching regulator, the amount of current passing through the coil is adjusted by changing the duty ratio of the pulse used in turning on/off the switch 207.

However, when the load suddenly changes, current whose direction is opposite to the direction of current which normally passes through the current detection circuit 206 passes through the current detection circuit 206, and therefore, in some cases, the current detection circuit 206 cannot correctly detect the current when the current decreases, and thus, a current sense circuit may malfunction to cause, for example, oscillation of the output voltage.

### SUMMARY OF THE INVENTION

The present invention has been made in view of the above, and an object of the present invention is to provide a current mode step-down switching regulator having an overvoltage protection circuit, which, when a load suddenly decreases, suppresses overshoot of output voltage, detects change in the output voltage even if being a current mode step-down switching regulator, and thus, can prevent malfunction such as oscillation of the output voltage.

A semiconductor device according to the present invention is a semiconductor device for a switching regulator for converting input direct current voltage input from a direct current power supply to set direct current output voltage and outputting the output voltage from an output terminal, includes: an overvoltage protection circuit for: comparing a target voltage with the output voltage at the output terminal: and making the output terminal in a discharge state when the output voltage exceeds the target voltage.

Here, the target voltage is defined as voltage which is set as a control target to be given to a load of the output voltage. In an embodiment of the present invention, reference voltage to be compared with divided voltage determined by dividing the output voltage by a voltage divider circuit in an error amplifier 3 is set as divided voltage when the output voltage matches the target voltage. Therefore, when the divided voltage determined by dividing the output voltage by the voltage divider circuit exceeds the reference voltage, it is considered that the output voltage exceeds the target voltage.

In the semiconductor device according to the present invention, the overvoltage protection circuit includes: a comparator for comparing the target voltage with the output voltage; and outputting a control signal when the output voltage exceeds the target voltage, and a discharge switch which is turned on by the output signal to connect the output terminal to a ground point.

The semiconductor device according to the present invention, further includes: a switch for turning on/off a coil provided in the switching regulator for converting the input direct current voltage to the output voltage and supplying the output voltage to a load; and a control circuit for controlling on/off of the switch, in which: the discharge switch is a MOS transistor; and a size of the transistor is set so that, in an ON state, a resistance which is a difference between a current passing through the coil when the load reaches a maximum value and a current passing through the coil when the load reaches a minimum value becomes a resistance of a value divided by a set value of the output voltage.

In the semiconductor device according to present invention, the comparator is structured such that offset voltage is added to a terminal side to which the target voltage is input.

The switching regulator according to the present invention is a switching regulator for converting input direct current voltage input from a direct current power supply to set direct current output voltage and outputting the output voltage to a load connected to an output terminal, and includes: a coil connected to the output terminal; a switch for passing current through the coil; a control circuit for controlling on/off of the switch; and an overvoltage protection circuit for: comparing a target voltage with the output voltage at the output terminal; and making the output terminal in a discharge state when the output voltage exceeds the target voltage.

By adopting the structure described above in a current mode switching regulator, according to the present invention, when a load, suddenly decreases and the output voltage rises, the overvoltage protection circuit can directly lower the voltage of the output terminal by discharge such that the output voltage becomes a target value.

Therefore, according to the present invention, because the output voltage is controlled with current being always passing through the coil, that is, with current passing through the coil being detected, and at the same time, control to suppress overshoot of the output voltage can be performed, change in the load can be accommodated immediately to suppress overshoot, and, even a current mode switching regulator can supply stable output voltage to a load without malfunction (e.g., oscillation).

### BRIEF DESCRIPTION OF THE DRAWINGS

In the accompanying drawings:

FIG. 1 is a conceptual diagram illustrating an exemplary structure of a current mode switching regulator using an overvoltage protection circuit according to an embodiment of the present invention;

FIG. 2 is a waveform diagram for explaining operation of the current mode switching regulator illustrated in FIG. 1;

FIG. 3 is a waveform diagram for explaining operation of slope compensation of the current mode switching regulator illustrated in FIG. 1;

FIG. 4 is a conceptual diagram illustrating an exemplary structure of the overvoltage protection circuit of the current mode switching regulator illustrated in FIG. 1; and

FIG. 5 is a conceptual diagram illustrating an exemplary structure of a current mode switching regulator having a conventional function of suppressing overshoot.

### DETAILED DESCRIPTION OF THE PREFERRED EMBODIMENT

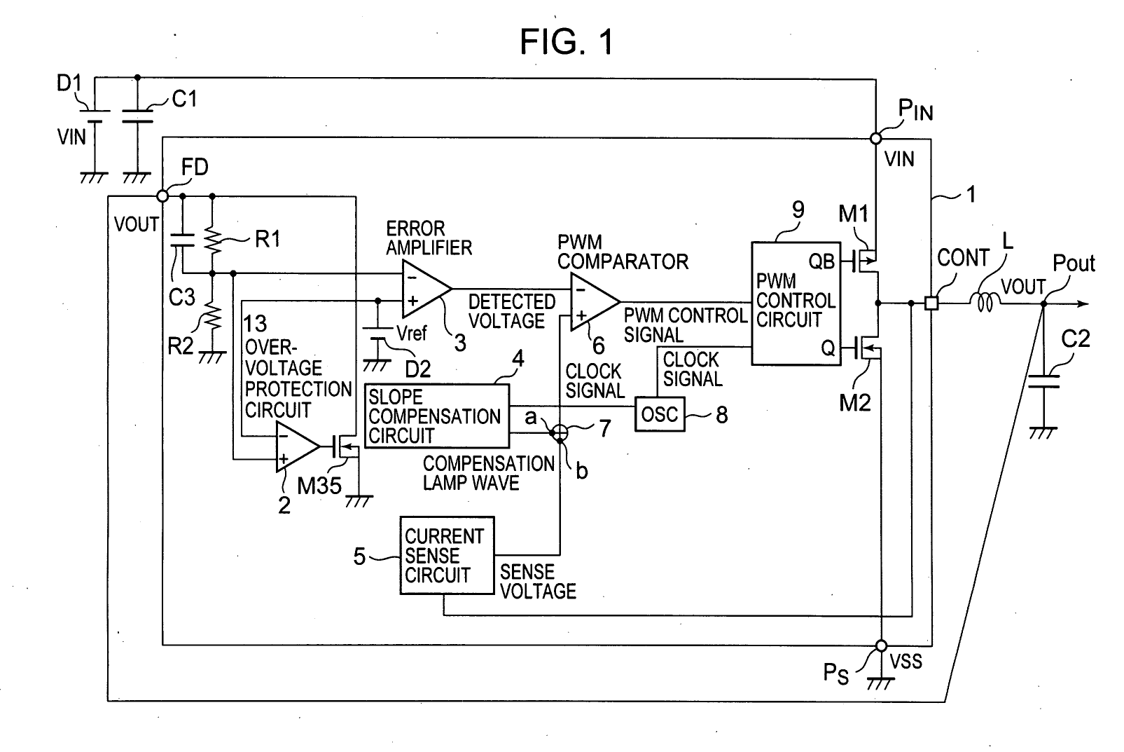

A semiconductor device 1 for a current mode step-down switching regulator using an overvoltage protection circuit 13 according to an embodiment of the present invention will be described in the following with reference to the drawings. FIG. 1 is a block diagram illustrating an exemplary structure of a step-down switching regulator according to this embodiment. The most distinctive feature of the present invention is the overvoltage protection circuit 13 provided to suppress overshoot of output voltage Vout which is output from an output terminal Pout to the load when a load suddenly decreases, and the detail thereof will be described in the following.

In FIG. 1, the current mode step-down switching regulator according to this embodiment has the semiconductor device 1 for the current mode step-down switching regulator, a coil L for voltage conversion (in this embodiment, step-down), and a capacitor C2 for smoothing voltage which is output from the coil L. When a P-channel MOS transistor (hereinafter referred to as P-channel transistor) M1 is turned on and an N-channel MOS transistor (hereinafter referred to as N-channel transistor) M2 is turned off, current passes from a power supply D1 through a terminal Pin and an output terminal (terminal CONT) into the coil L, and an input voltage Vin which is voltage of the power supply D1 is built up as electric energy (i.e., charge) in the coil L. When the P-channel transistor M1 is turned off and the N-channel transistor M2 is turned on, the electric energy which has been built up in the coil L is discharged (so-called synchronous control system). A capacitor cl is connected between an output terminal of the power supply D1 and a ground point.

A source of the P-channel transistor M1 is connected to the terminal Pin, that is, the source is connected through the terminal Pin to the power supply D1. A source of the N-channel transistor M2 is connected to a terminal Ps, that is, the source is grounded through the terminal Ps. The overvoltage protection circuit 13, an error amplifier 3, a slope compensation circuit 4, a current sense circuit 5, a PWM comparator 6, an adder 7, an oscillator 8, a PWM control circuit 9, and an OR circuit 12 are connected through the terminal Pin to the power supply D1, and connected through the terminal Ps to a ground point.

As described above, in the current mode step-down switching regulator, the output voltage is adjusted by having a period during which electric energy is built up in the coil L and a period during which discharge is made, and voltage equated (integrated) by the coil L and the capacitor C2 is supplied to the load.

A drain of the P-channel transistor M1 is connected to a drain of the N-channel transistor M2 through the terminal CONT (series connection), and one end of the coil L is connected to the terminal CONT while another end of the coil L is connected to the load (i.e., to the output terminal Pout). A gate of the P-channel transistor M1 is connected to a terminal QB of the PWM control circuit 9 and a gate of the N-channel transistor M2 is connected to a terminal Q of the PWM control circuit 9.

Voltage of the output terminal which is a node between the capacitor C2 and the coil L, that is, divided voltage obtained by dividing the output voltage Vout by a resistance R1 and a resistance R2 (serially connected voltage divider circuits) is input to an inverting terminal of the error amplifier 3, and a reference voltage Vref which is output by a reference voltage source D2 is input to a non-inverting terminal of the error amplifier 3. A difference between the divided voltage and the reference voltage Vref is amplified, and the amplified result is output as detected voltage to an inverting input terminal of the PWM comparator 6. A capacitor C3 for phase control of change in the output voltage to be inputted to a node between the resistance R1 and the resistance R2 is inserted between a terminal FD to which the output voltage Vout is input and the node between the resistance R1 and the resistance R2.

With regard to the output voltage Vout which is output by the switching regulator, a target voltage which is a target value of voltage to be supplied to the load is set as the reference voltage Vref of the reference voltage source D2 which is connected to the error amplifier 3. More specifically, in this embodiment, the target voltage is defined as voltage which is set as a control target to be given to the load of the output voltage. In the error amplifier 3, as described above, the reference voltage is voltage to be compared with divided voltage determined by dividing the output voltage by the voltage divider circuit, and the divided voltage when the output voltage matches the target voltage is set. Therefore, when the divided voltage determined by dividing the output voltage by the voltage divider circuit exceeds the reference voltage, it is considered that the output voltage exceeds the target voltage.

The slope compensation circuit 4 generates a sawtooth compensating ramp wave (a voltage waveform which changes linearly in sequence with a slope m to be described later) in synchronization with a period T of a clock signal frequency generated by the oscillator 8, and outputs the wave to an input terminal a of the adder 7.

The current sense circuit 5 detects a value of current passing through the coil L, that is, change in the current corresponding to change in the load capacitor, generates sense voltage (which corresponds to the value of current passing through the coil) S1 and outputs the sense voltage to an input terminal b of the adder 7. The sense voltage undergoes slope compensation (correction) by voltage of the compensating ramp wave which is output by the slope compensation circuit 4.

Here, because the output voltage Vout changes according to the change in the current passing through the coil L, by determining the sense voltage corresponding to the change in the current passing through the coil L with regard to the voltage value of the compensating ramp wave for the slope compensation, and, as described below, giving feedback to the compensating ramp wave, control with high accuracy can be performed.

More specifically, a period during which the P-channel transistor M1 is on is adjusted correspondingly to the current through the coil L. Therefore, sense voltage which corresponds to the current passing through the coil L undergoes slope compensation by voltage of the compensating ramp wave and the output voltage is determined by the current passing through the coil L (primary information), and thus, the control can immediately respond to the change in the load.

As described above, the adder 7 adds the voltage of the compensating ramp wave which is output from the slope compensation circuit 4 (to be input to the input terminal a) and the sense voltage which is output from the current sense circuit 5 (to be input to the input terminal b). As a result, the sense voltage corresponding to the current passing through the coil L undergoes slope compensation by the compensating ramp wave, and the voltage is output to the non-inverting input terminal of the PWM comparator 6.

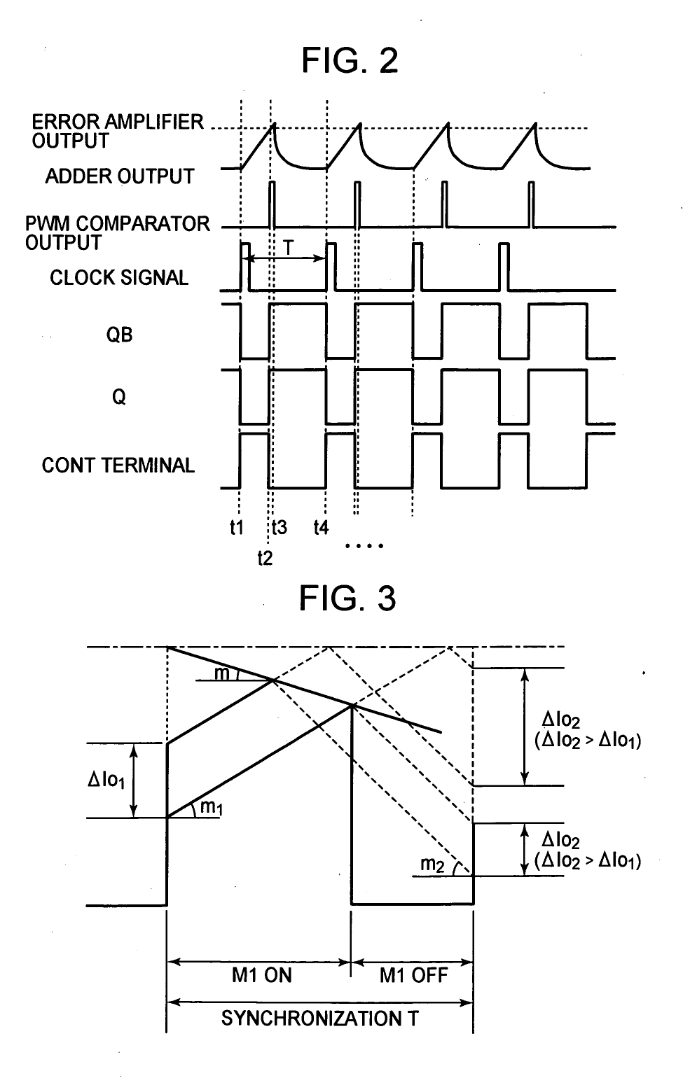

The PWM comparator 6 compares the detected voltage which is output from the error amplifier 3 and a value of the sense voltage which is input from the adder 7 after being corrected, and, as illustrated in FIG. 2, when the detected voltage exceeds the value of the voltage of the compensating ramp wave, a PWM control signal is output as a pulse at an H level.

The oscillator 8 periodically outputs a clock signal (a pulse at the H level) with the period T which is set in advance.

As illustrated in FIG. 2, the PWM control circuit 9 applies voltage at an L level to the gate of the P-channel transistor M1 through the output terminal QB in synchronization with a rising edge of the clock signal to turn on the P-channel transistor M1, and applies voltage at the L level to the gate of the N-channel transistor M2 through the output terminal Q to turn off the N-channel transistor M2.

Also, the PWM control circuit 9 applies voltage at the H level to the gate of the P-channel transistor M1 through the output terminal QB in synchronization with a rising edge of the PWM control signal (a pulse at the H level) to turn off the P-channel transistor M1, and applies voltage at the H level to the gate of the N-channel transistor M2 through the output terminal Q to turn on the N-channel transistor M2.

The overvoltage protection circuit 13 includes a comparator 2 and an N-channel transistor M35. When the comparator 2 detects that the output voltage Vout exceeds the target voltage set in advance with regard to the load, that is, when the comparator 2 detects that the divided voltage corresponding to the output voltage Vout exceeds the reference voltage Vref, the overvoltage protection circuit 13 outputs a pulse signal at the “H” level to a gate of the N-channel transistor M35 to turn on the N-channel transistor M35, change the output terminal Pout into a discharge state, and lower the output voltage Vout in order to protect the load and in order to protect the semiconductor device 1 for the switching regulator. Here, the divided voltage is input to a non-inverting input terminal of the comparator 2, and the reference voltage Vref is input to an inverting input terminal of the comparator. A source of the N-channel transistor M35 is grounded, a drain of the N-channel transistor M35 is connected to the output terminal Pout of the switching regulator, and a gate of the N-channel transistor M35 is connected to an output terminal of the comparator 2.

With regard to the slope compensation described above, it is known that, when a current mode switching regulator operates with the duty cycle of current passing through a coil being continuously 50% or more in a continuous mode, oscillation with the period being an integral multiple of the switching frequency, that is, subharmonic oscillation, is caused. Here, an ascending slope of the current passing through the coil is determined by the input voltage Vin and inductance value of the coil L, while a descending slope of the current through the coil is determined by energy consumption by the load connected to the output terminal.

Even within a same period, the duty ratios of turning on/off the P-channel transistor M1 and the N-channel transistor M2 often varies. As illustrated in FIG. 3, when current IL passing through the coil starts at a point deviating by ΔIo, in the next period, ΔIo1<ΔIo2 is established. Because the starting value of the current gradually increases and the operation becomes stable in several periods, subharmonic oscillation is caused.

Conversely, when control is performed such that the deviating current is ΔIo1>ΔIo2, that is, such that the starting value of current Io gradually decreases, the change gradually converges and the operation becomes stable.

Therefore, in order to make the operation stable even when the duty cycle of current through the coil which causes subharmonic oscillation is continuously 50% or more, it is necessary to decrease the starting current in a subsequent period, and thus, the above-described slope compensation is necessary.

In order to attain the stable operation, Δio1>Δio2 is required, and thus, generally, in the case of a current mode step-down switching regulator, it is necessary that the ascending slope m of the slope compensation satisfies:

m≦(m2−m1)/2=(2Vout−Vin)/2L,

where m2 is the descending slope of the current through the coil, that is, the rate of decrease in the current, which is expressed as

m2=(Vout−Vin)/L,

and where m1 is the ascending slope of the current through the coil, that is, the rate of increase in the current, which is expressed as

m1=Vin/L.

The slope compensation circuit 4 outputs a sawtooth compensating ramp wave for the slope compensation having the above-described slope m in synchronization with the clock signal which is output by the oscillator 8.

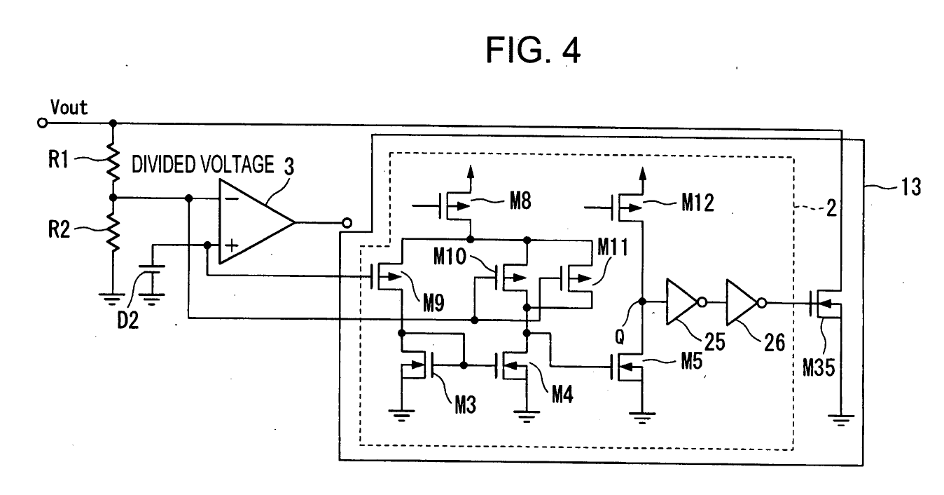

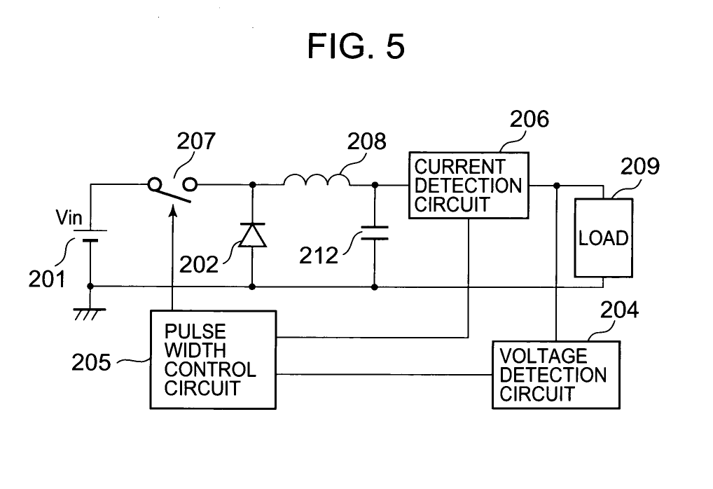

Next, the overvoltage protection circuit 13 according to the embodiment of the present invention is now described in detail with reference to FIG. 4. FIG. 4 is a conceptual diagram illustrating an exemplary circuit structure of the overvoltage protection circuit 13 according to this embodiment.

In the overvoltage protection circuit 13, the comparator 2 includes P-channel transistors M8, M9, M10, M11, and M12, N-channel transistors M3, M4, and M5, and inverters (NOT circuits) 25 and 26.

A source of the P-channel transistor M8 is connected to wiring of a power supply voltage (Vin) and a gate of the P-channel transistor M8 is connected to a reference voltage which is not shown to form a constant current source.

A source of the P-channel transistor M9 is connected to a drain of the P-channel transistor M8, and the reference voltage Vref is input to a gate of the P-channel transistor M9.

The size of the P-channel transistor M10 is similar to that of the P-channel transistor M9. A source of the P-channel transistor M10 is connected to the drain of the P-channel transistor M8, and the divided voltage is input to a gate of the P-channel transistor M10.

A source of the P-channel transistor M11 is connected to the drain of the N-channel transistor M3, and the divided voltage is input to a gate of the P-channel transistor M11.

A source of the N-channel transistor M3 is grounded, and a drain of the N-channel transistor M3 is connected to a gate of the N-channel transistor M3 itself and to a drain of the P-channel transistor M9.

A source of the N-channel transistor M4 is grounded, a drain of the N-channel transistor M4 is connected to drains of the P-channel transistors M10 and M11, and a gate of the N-channel transistor M4 is connected to the gate of the N-channel transistor M3.

A source of the P-channel transistor M12 is connected to the wiring of the power supply voltage (Vin) and a gate of the P-channel transistor M12 is connected to a reference voltage (not shown) to form, similarly to the case of the P-channel transistor M8, a constant current source.

A source of the N-channel transistor M5 is grounded, and a drain of the N-channel transistor M5 is connected to a drain of the P-channel transistor M12 at a node Q, and a gate of the N-channel transistor M5 is connected to the drain of the N-channel transistor M4 (i.e., a node between the drain of the P-channel transistor M10 and the drain of the N-channel transistor M4).

An input terminal of the inverter 25 is connected to the node Q between the drain of the P-channel transistor M12 and the drain of the N-channel transistor M5, and an output terminal of the inverter 25 is connected to an input terminal of the inverter 26.

An output terminal of the inverter 26 is connected to the gate of the N-channel transistor M35.

In the structure described above, the N-channel transistors M3 and M4 form a current mirror circuit and the N-channel transistor M3 is formed on a reference side.

The P-channel transistor M11 is provided so as to be in parallel with the P-channel transistor M10 in order to generate an offset with respect to the divided voltage which is input. Therefore, while, conventionally, a reference voltage source which supplies reference voltage Vref′ that is higher, for example, by about 10%, than the reference voltage Vref is provided for the overvoltage protection circuit on the outside in addition to the reference voltage source D2 which supplies the reference voltage Vref, this embodiment can eliminate such need.

When the divided voltage exceeds a set voltage which is higher than the reference voltage Vref by the offset by the P-channel transistor M11 (when overshoot of the output voltage is caused), the comparator 2 makes the voltage of the node at the “H” level and outputs voltage at the “H level (Vin)” to the gate of the N-channel transistor M35. On the other hand, when the comparator 2 detects that the divided voltage does not exceed the set voltage, the comparator 2 makes the voltage of the node at the “L” level and outputs voltage at the “L level (ground voltage)” to the gate of the N-channel transistor M35.

More specifically, when the load suddenly decreases and the overvoltage protection circuit 13 detects that overshoot of the output voltage is caused, the overvoltage protection circuit 13 changes the output terminal of the switching regulator into a discharge state (that is, a state where the output terminal is grounded through an ON resistance) to suppress the overshoot.

The size of the above-described N-channel transistor M35 is set according to the following equations so as to correspond to a switching regulator to be adopted.

As described above, overshoot of the output voltage is caused when the load suddenly changes from a heavy load to a light load.

More specifically, because the load changes from a heavy load to a light load, electric power consumed when the load is heavy is required to be decreased so as to correspond to the light load. However, as described above as a problem in the related art, the electric power is decreased due to the delay, whereby electric power more than required is supplied, and thus, overshoot of Vout is caused.

With regard to the above-described delay, when the output voltage Vout exceeds the voltage which is set as the control value of the output voltage Vout (the reference voltage Vref or the reference voltage Vref′), the overvoltage protection circuit 13 according to this embodiment lowers the output voltage Vout to suppress the generation of the overshoot.

However, if the size of the N-channel transistor M35 is such that too much current flows in an ON state, the output voltage is lowered more than required.

Therefore, the size of the N-channel transistor M35 is required to be set as, for example, described below.

When the load connected to the output terminal is a heavy load, electric power supplied to the load is set to PH (current: Iouth) and when the load is a light load, electric power supplied to the load is set to PL (current: Ioutl). The electric powers PH and PL are expressed as follows:

PH=Iouth×Vout and

PL=Ioutl×Vout.

Here, assuming that the ON resistance of the N-channel transistor M35 is rD, and then,

Vout×(Iouth−Ioutl)=Vout²/rD,

from which the following equation is obtained:

rD=Vout/(Iouth−Ioutl).

More specifically, when the voltage which is output from the comparator 2 is at the “H” level (Vin), by making the ON resistance of the N-channel transistor M35 the output voltage Vout divided by the difference between the current value Iouth passing through the heavy load and the current value Ioutl passing through the light load, the output voltage Vout is prevented from being lowered more than required.

For example, when the output voltage Vout 4.0 V, Iouth=300 mA, and Ioutl=1 mA, according to the above equation, tD=13.38Ω is established. Therefore, the size of the N-channel transistor M35 is set such that the ON resistance is 13.38Ω when Vout=4 V.

Operation of the step-down switching regulator illustrated in FIG. 1 including operation of the overvoltage protection circuit 13 according to this embodiment is now described in the following with reference to FIG. 2.

When, at time t1, the oscillator 8 outputs a clock signal as a pulse signal at the H level, the PWM control circuit 9 changes the output terminal QB from an H into L level and changes the output terminal Q from an H into L level.

Accordingly, the P-channel transistor M1 is turned into an ON state and the N-channel transistor M2 is turned into an OFF state. Because drive current passes from the reference voltage source D1 to the coil L, electric energy builds up in the coil L.

Here, the slope compensation circuit 4 starts output of a compensating ramp wave which changes linearly with the slope m in synchronization with the above-described clock signal.

The adder 7 adds the value of the voltage of the compensating ramp wave which is input to the input terminal a and above-described sense voltage S1 which is input from the input terminal b, and the result of the addition which is the sense voltage subjected to the slope compensation by the voltage of the ramp wave is output to the inverting input terminal of the PWM comparator 6.

Therefore, the PWM comparator 6 compares the detected voltage which is input from the error amplifier 3 with the voltage which is obtained by collecting the sense voltage S1 corresponding to the current passing through the coil L with the voltage corrected with the voltage of the compensating ramp wave, and the value of the current passing through the coil L is fed back in real time and the PWM control signal for controlling the period of time during which the P-channel transistor M1 is on can be output.

When the load suddenly decrease (becomes light) with the P-channel transistor M1 being turned on and current passing through the coil L, the output voltage Vout gradually increases.

Here, the output voltage of the error amplifier 3 is detected and the current sense circuit 5 detects decrease in the current passing through the coil L, and feedback is performed to the compensating ramp wave, but it takes time until the P-channel transistor M1 is turned off.

On the other hand, when the overvoltage protection circuit 13 detects that the divided voltage generated from the output voltage exceeds the reference voltage Vref (or the reference voltage Vref′ which is higher than Vref) which is set in advance, the overvoltage protection circuit 13 turns on the N-channel transistor M35, immediately lowers the output voltage Vout, and suppresses the generation of the overshoot. When the overvoltage protection circuit 13 detects that the divided voltage generated from the output voltage is equal to or lower than the reference voltage Vref (or the reference voltage Vref′ which is higher than Vref) which is set in advance, the overvoltage protection circuit 13 turns off the N-channel transistor M35 and immediately stops discharge of the output voltage Vout. The overvoltage protection circuit 13 operates to suppress overshoot at all times by repeating the cycle from time t1 to time t4 which is described below.

At time t2, when the PWM comparator 6 detects that the voltage of the compensating ramp wave which linearly increases with the slope m exceeds the output voltage of the error amplifier 3, the PWM comparator 6 changes the voltage of the output PWM control signal from an L into H level.

Because of the change of the voltage of the PWM control signal which is input from the PWM comparator 6 from L into H level, the PWM control circuit 9 changes the voltage which is output from the output terminal QB from an L into H level and changes the voltage which is output from the output terminal Q from an L into H level.

Accordingly, the P-channel transistor M1 is turned off and the N-channel transistor M2 is turned on, and discharge of the electric energy which has been built up in the coil L starts. The discharge is made at a speed which corresponds to the slope of the above-described ON resistance rD of the N-channel transistor M35.

Then, at time t3, when the form of the compensating ramp wave reaches a set maximum value, the slope compensation circuit 4 stops output of the compensating ramp wave.

When the PWM comparator 6 detects that the voltage of the compensating ramp wave is lower than the output voltage of the error amplifier 3, the PWM comparator 6 changes the voltage of the PWM control signal which is output from an H into L level.

Then, at time t4, the oscillator 8 outputs a clock signal, the next period starts, and, as described above, the operation from time t1 to time t4 is repeated.

Although, in the above description, processing of discharge of excess charge is performed within one cycle, the relationship between the amount of built-up charge and the set ON resistance rD of the N-channel transistor M35 may be adjusted to suppress the overshoot in a plurality of cycles (T×n, n is the number of the cycles).

The current mode switching regulator semiconductor device according to this embodiment has the structure described above. By providing the overvoltage protection circuit 13 described above thereto, even if the output voltage Vout suddenly increases, because the N-channel transistor M35 lowers the output voltage Vout when the comparator 2 detects that the output voltage Vout exceeds the reference voltage, as in the conventional case, the delay until the output voltage Vout is lowered can be decreased, and thus, the overshoot of the output voltage Vout can be suppressed.

Further, according to this embodiment, because the overshoot can be suppressed, the P-channel transistor M1 is not completely turned off during a period of the clock signal which is output by the oscillator 8 (a state where no current passes through the coil L during the period) so that current is not supplied, that is, unlike a conventional case, control is not performed with the duty ratio of 0% and with the duty ratio of 100%, so the output voltage Vout does not oscillate.

Still further, although an overvoltage protection circuit according to the present invention is described in the current mode step-down switching regulator in this embodiment, the overvoltage protection circuit according to the present invention may also be used in a current mode step-up switching regulator.

What is claimed is:

1. A semiconductor device for a switching regulator for converting input direct current voltage input from a direct current power supply to set direct current output voltage and outputting the output voltage from an output terminal, comprising:
an overvoltage protection circuit for:
comparing a target voltage with the output voltage at the output terminal; and
making the output terminal in a discharge state when the output voltage exceeds the target voltage.

2. A semiconductor device according to claim 1, wherein the overvoltage protection circuit comprises:
a comparator for:
comparing the target voltage with the output voltage; and
outputting a control signal when the output voltage exceeds the target voltage; and
a discharge switch which is turned on by the output signal to connect the output terminal to a ground point.

3. A semiconductor device according to claim 2, further comprising:
a switch for turning on/off a coil provided in the switching regulator for converting the input direct current voltage to the output voltage and supplying the output voltage to a load; and
a control circuit for controlling on/off of the switch, wherein:
the discharge switch comprises a MOS transistor; and
a size of the transistor is set so that, in an ON state, a resistance which is a difference between a current passing through the coil when the load reaches a maximum value and a current passing through the coil when the load reaches a minimum value becomes a resistance of a value divided by a set value of the output voltage.

4. A semiconductor device according to claim 2, wherein the comparator is structured such that offset voltage is added to a terminal side to which the target voltage is input.

5. A semiconductor device according to claim 3, wherein the comparator is structured so that the offset voltage is added to the terminal side to which the target voltage is input.

6. A switching regulator for converting input direct current voltage input from a direct current power supply to set direct current output voltage and outputting the output voltage to a load connected to an output terminal, comprising:
a coil connected to the output terminal;
a switch for passing current through the coil;
a control circuit for controlling on/off of the switch; and
an overvoltage protection circuit for:
comparing a target voltage with the output voltage at the output terminal; and
making the output terminal in a discharge state when the output voltage exceeds the target voltage.
